(19) United States
(12) Patent Application Publication
(10) Pub. No.: US 2023/0162146 A1
(43) Pub. Date: May 25, 2023

(54) VALUE CHAIN PROVIDING APPARATUS, VALUE CHAIN PROVIDING SYSTEM, AND VALUE CHAIN PROVISION METHOD

(71) Applicant: Hitachi, Ltd., Tokyo (JP)

(72) Inventors: Tazu NOMOTO, Tokyo (JP); Takahiro OGURA, Tokyo (JP); Teppei INOUE, Tokyo (JP)

(73) Assignee: Hitachi, Ltd., Tokyo (JP)

(21) Appl. No.: 17/946,575

(22) Filed: Sep. 16, 2022

(30) Foreign Application Priority Data
Nov. 25, 2021 (JP) 2021-191213

(51) Int. Cl. G06Q 10/08; G06Q 30/02; G06Q 30/06

(52) U.S. Cl. CPC G06Q 10/087; G06Q 30/0202; G06Q 30/0637; G06Q 30/0282

(57) ABSTRACT

A value chain providing apparatus for a value chain in which at least two or more business entities from material procurement to sales of a product participate. The apparatus includes: a storage unit, a participating business entity registration unit configured to accept and store in the storage unit a value that can be provided, a cost of the value, and a provision lead time of the value from each participating business entity participating in the value chain, and a value chain design unit configured to receive demand information including a necessary demand and a delivery date from a business entity that procures using the value chain, and calculate a combination of participating business entities satisfying the demand information as a value chain candidate.

### TECHNICAL FIELD

The present invention relates to a value chain providing apparatus, a value chain providing system, and a value chain provision method.

### BACKGROUND ART

PTL 1 describes “a plurality of business-related companies, each of which has a terminal connectable to a network, and a server that can communicate with each of said terminals via said network, are constructed, and the server is provided with a storage means for storing planning data concerning transactions of goods collected from each of the plurality of companies, and a means for re-planning and updating the planning data of each of said companies based on the planning data of each of said companies. The server is provided with a function for sending back the updated planning data to each company whose planning data has been updated.”

### CITATION LIST

### Patent Literature

PTL 1: JP-A-2005-122364

### Technical Problem

In the technique described in the above PTL 1, the companies that make up the value chain are given companies. On the other hand, in order to accurately construct the best value chain, the companies that make up the value chain should be dynamically composed of companies that are efficient and up-to-date at the time of design of the value chain. In the above technology, there is no mention of such a point, and it is not possible to obtain the best design result with accuracy.

An object of the invention is to dynamically configure efficient business entities in the latest state at the time of design of the value chain.

### SUMMARY OF INVENTION

In order to solve the above problem, the present application employs, for example, a technique described in the claims. The invention includes a plurality of means for solving the above problems, and an example thereof is a value chain providing apparatus for a value chain in which at least two or more business entities from material procurement to sales of a product participate, and including: a storage unit; a participating business entity registration unit configured to accept and store in the storage unit a value that can be provided, a cost of the value, and a provision lead time of the value from each participating business entity participating in the value chain; and a value chain design unit configured to receive demand information including a necessary demand and a delivery date from a business entity that procures using the value chain, and calculate a combination of participating business entities satisfying the demand information as a value chain candidate.

### Advantageous Effect

According to the invention, it is possible to provide a technique for dynamically configuring an efficient business entity in the latest state at the time of design of the value chain.

Problems to be solved, configurations, and effects other than those described above will be apparent from the description of the following embodiments.

### BRIEF DESCRIPTION OF DRAWINGS

FIG. 1 is a diagram illustrating a configuration example of a value chain providing system.

FIG. 2 is a diagram illustrating an example of the data structure of the participating business entity model information.

FIG. 3 is a diagram illustrating an example of the data structure of member business entity information.

FIG. 4 is a diagram illustrating an example of the data structure of transaction information.

FIG. 5 is a diagram illustrating an example of the data structure of VC(Value Chain) design plan information.

FIG. 6 is a diagram illustrating an example of the data structure of the participating business entity priority information.

FIG. 7 is a diagram illustrating a hardware configuration example of the value chain providing apparatus.

FIG. 8 is a diagram illustrating an example of the flow of the registration process of participating business entities.

FIG. 9 is a diagram illustrating a screen example of the registration process of participating business entities.

FIG. 10 is a diagram illustrating an example of the flow of priority calculation process.

FIG. 11 is a diagram illustrating an example of the flow of the value chain design process.

FIG. 12 is a diagram illustrating a screen example of value chain design process.

FIG. 13 is a diagram illustrating a detailed screen example of value chain design process.

FIG. 14 is a diagram illustrating an example of the flow of value chain execution process.

FIG. 15 is a diagram illustrating an example of the flow of value chain review process.

### DESCRIPTION OF EMBODIMENTS

In the following embodiments, description may be divided into plural sections or embodiments when necessary for convenience. Unless particularly specified, the sections or embodiments are not independent of each other, but have a relation such that one is a modification, detailed description, supplementary description, or the like of a part or all of the others.

In the following embodiments, when a number or the like (including a number, a numeric value, an amount, a range, and the like) of an element is referred to, the number or the like is not limited to a specific number, and may be equal to, greater than or less than the specific number, unless otherwise specified or clearly limited to the specific number in principle.

Further, in the embodiments described below, it is needless to say that the constituent elements (including element steps) are not always essential unless otherwise stated or considered as apparently essential in principle.

Similarly, in the following embodiments, when reference is made to shapes, positional relations, and the like of the constituent elements or the like, those having substantially approximate or similar shapes or the like are inclusive unless otherwise particularly specified or considered to be clearly not inclusive in principle. The same applies to numeric values and ranges.

In all the drawings for illustrating the embodiments, the same members are denoted by the same reference signs in principle, and repetitive descriptions thereof will be omitted. However, a different reference sign or name may be given to the same member when a name shared by members before and after a change due to an environmental change or the like is highly probable to cause confusion. Hereinafter, each embodiment of the invention will be described with reference to the drawings.

In recent years, business entities, not limited to companies, tend to be required to achieve both resilience and management efficiency. One possible solution to this is an open value chain that originates from the customer. In addition, since social demands on ESG (Environment, Social, and Corporate Governance) are also becoming stronger, it is also becoming necessary to realize this in the value chain.

By providing a system and apparatus that serves as a basis for constructing a value chain in which at least two or more business entities from material procurement to sales of products, the present invention realizes that a business entity that participates in it and provides value (also referred to as a participating business entity) and a business entity that uses the value chain (also referred to as a member business entity) are dynamically connected. In other words, it provides a foundation for dynamically constructing a value chain with efficient business entities that are up-to-date at the time of design. It will also provide a foundation that can meet ESG-related requirements.

In the following description, an “input unit”, an “output unit”, and an “communication unit” may be one or more interface devices. The one or more interface devices may be at least one of the following.
One or more input/output (I/O) interface devices. The I/O interface device is an interface device for at least one of an I/O device or a remote display computer. The I/O interface device for the display computer may be a communication interface device. At least one I/O device may be a user interface device, for example, either an input device such as a keyboard and a pointing device or an output device such as a display device.
One or more communication interface devices. The one or more communication interface devices may be one or more communication interface devices of the same type (for example, one or more network interface cards (NIC)) or may be two or more communication interface devices of different types (for example, an NIC and a host bus adapter (HBA)).

In the following description, “memory” is one or more memory devices as an example of one or more storage devices, and may typically be a random access memory device. At least one memory device in the memory may be a volatile memory device or a non-volatile memory device.

In the following description, a “external storage device” may be one or more persistent storage devices as an example of one or more storage devices. Typically, the persistent storage device may be a non-volatile storage device (for example, an auxiliary storage device), and may specifically be, for example, a hard disk drive (HDD), a solid state drive (SSD), a non-volatile memory express (NVME) drive, or a storage class memory (SCM).

In the following description, a “storage unit” or an “external storage device” may be a memory or both of a memory and a persistent storage device.

In the following description, a “processing unit” or a “processor” may be one or more processor devices. Typically, at least one processor device may be a microprocessor device such as a central processing unit (CPU), and may also be a processor device of another type such as a graphics processing unit (GPU). At least one processor device may be a single-core processor device or a multi-core processor device. At least one processor device may be a processor core. At least one processor device may be a processor device in a broad sense, such as a circuit (for example, a field-programmable gate array (FPGA), a complex programmable logic device (CPLD), or an application specific integrated circuit (ASIC)) which is a collection of gate arrays in a hardware description language that performs a partial or entire processing.

In the following description, a “value chain providing system” may be a system including one or more physical computers or a system (for example, a cloud computing system) implemented on a physical calculation resource group (for example, a cloud computing platform). “Displaying” display information by the value chain providing system may be displaying the display information on a display device included in a computer, or may be transmitting the display information from the computer to a display computer (in the latter case, the display information is displayed by the display computer).

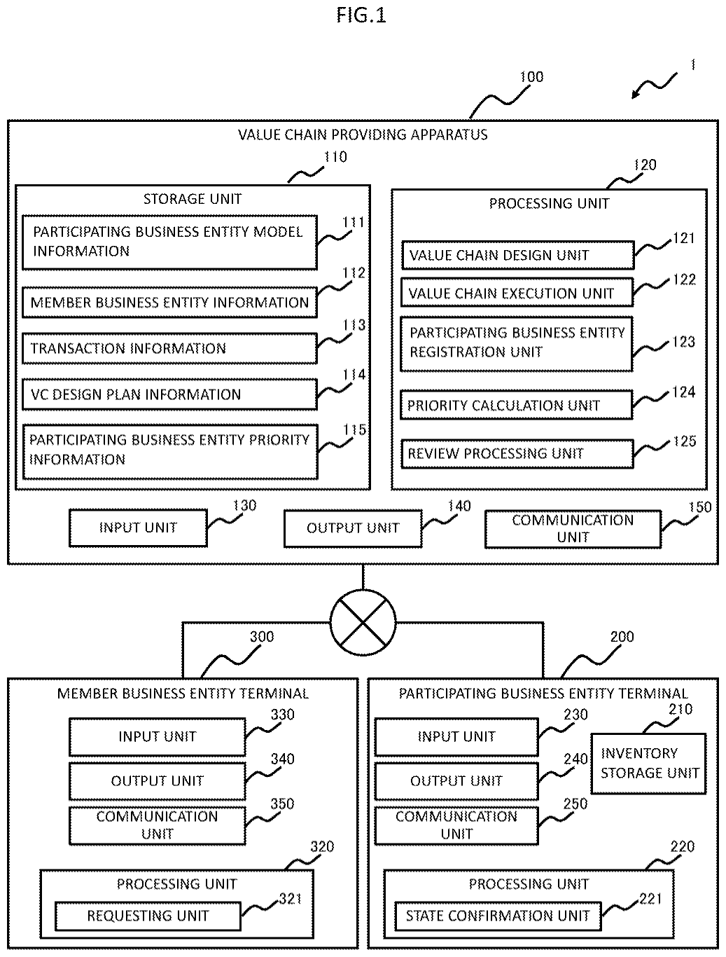

FIG. 1 is a diagram illustrating a configuration example of a value chain providing system. The value chain providing system 1 includes a value chain providing apparatus 100, a participating business entity terminal 200, and a member business entity terminal 300. The value chain providing system 1 includes a group of devices corresponding to the usage environment such as a display computer that is communicatively connected via a network not shown in the figure.

Although not shown in the figure, the network is, for example, any one or a combination of a communication network using a part or all of a general public line such as a local area network (LAN), a wide area network (WAN), a virtual private network (VPN), and the Internet, a mobile phone communication network, and the like. The network may be a wireless communication network such as Wi-Fi (registered trademark) or 5th Generation (5G).

The value chain providing apparatus 100 is a processing device including a storage unit 110, a processing unit 120, an input unit 130, an output unit 140, and a communication unit 150. The storage unit 110 includes the participating business entity model information 111, the member business entity information 112, the transaction information 113, the VC (Value Chain) design plan information 114, and the participating business entity priority information 115. The processing unit 120 includes a value chain design unit 121, a value chain execution unit 122, a participating business entity registration unit 123, a priority calculation unit 124, and a review processing unit 125.

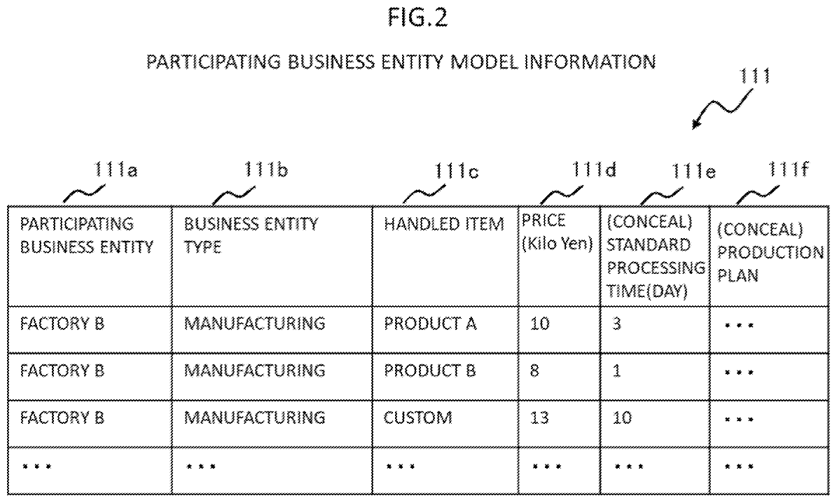

FIG. 2 is a diagram illustrating an example of a data structure of participating business entity model information. In the participating business entity model information 111, at least the value that can be provided, the cost of the value, and the lead time provided by the value are associated and stored for each participating business entity participating in the value chain.

In the participating business entity model information 111, for each participating business entity 111a, the business entity type 111b, the handled item 111c, the price 111d, the standard processing time 111e, and the production plan 111f are correlated and stored. The production plan 111f is not limited to this, and may be any business information corresponding to the business entity type 111b. For example, it is a constraint condition such as upper limit of value that can be provided, performance, etc. In addition, it may be quantifiable information such as delivery date, cost, number of transports, transportation speed, etc.

The participating business entity 111a contains information that identifies companies and other entities (participating business entities) that wish to participate in the various value chains to be constructed. The business entity type 111b contains the type of value provided by the participating business entity identified by the participating business entity 111a. Business entity types include, for example, sales companies, warehouses, manufacturing (factories), transportation industries, suppliers, and the like.

The handled item 111c contains specific items of value provided by the participating business entities identified by the participating business entity 111a. The price 111d stores the price of a specific item of value provided by the participating business entity identified by the participating business entity 111a. The standard processing time 111e stores a specific standard lead time (standard period from order to delivery) of value provided by the participating business entity identified by the participating business entity 111a. The production plan 111f stores a specific production plan (expected supply scale) of the value provided by the participating business entity specified by the participating business entity 111a. The information contained in the standard processing time 111e and the production plan 111f is necessary for building a value chain, but since it is also information that should be kept secret from other than the participating business entity itself, it is stored with predetermined encryption. In addition to this, the participating business entity model information 111 may include information corresponding to a plurality of business information.

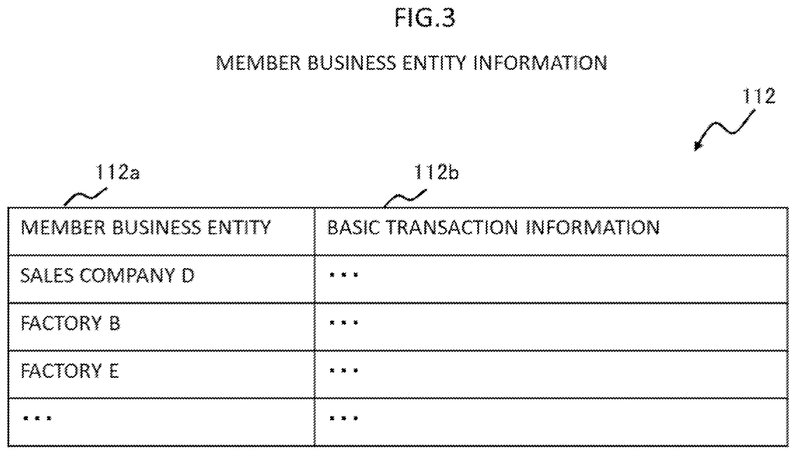

FIG. 3 is a diagram illustrating an example of the data structure of member business entity information. In the member business entity information 112, at least the basic transaction information 112b is associated and stored in the member business entity 112a, which identifies the member business entity that procures using the value chain. Basic transaction information 112b includes transaction information necessary for the member business entity to use the value chain, such as settlement information possessed by the member business entity identified by the member business entity 112a and the e-mail address of the contact information of the value chain counter.

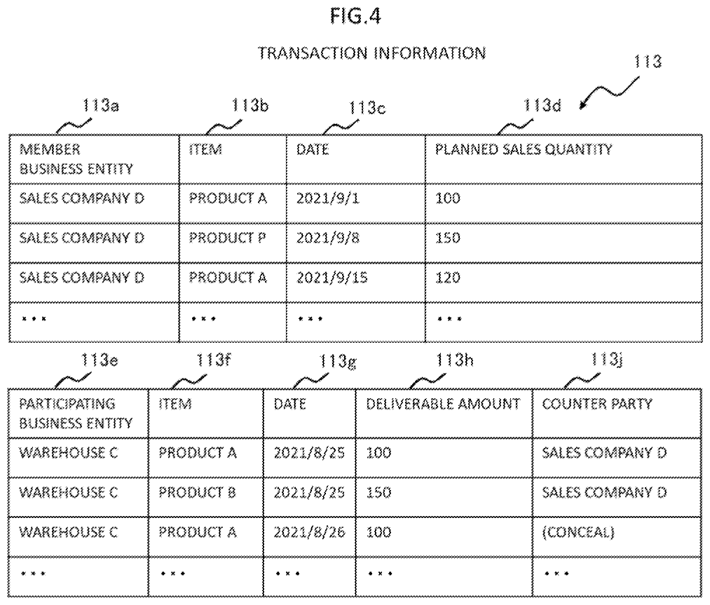

FIG. 4 is a diagram illustrating an example of a data structure of transaction information. The transaction information 113 contains transaction data for which the value chain is designed. Specifically, the transaction information 113 contains demand information including a member business entity 113a, an item 113b that identifies the value procured by the member business entity, a date 113c indicating the delivery date, and a planned sales quantity 113d that is a required amount.

The transaction information 113 contains a supply information including a participating business entity 113e, an item 113f that identifies the value provided by the participating business entity, a date 113g indicating the delivery date, a deliverable amount 113h, and a counterparty 113j indicating the buyer. Since the counterparty 113j is information that should be kept secret to persons other than the counterparty and the participating business entity itself, it is stored with predetermined encryption.

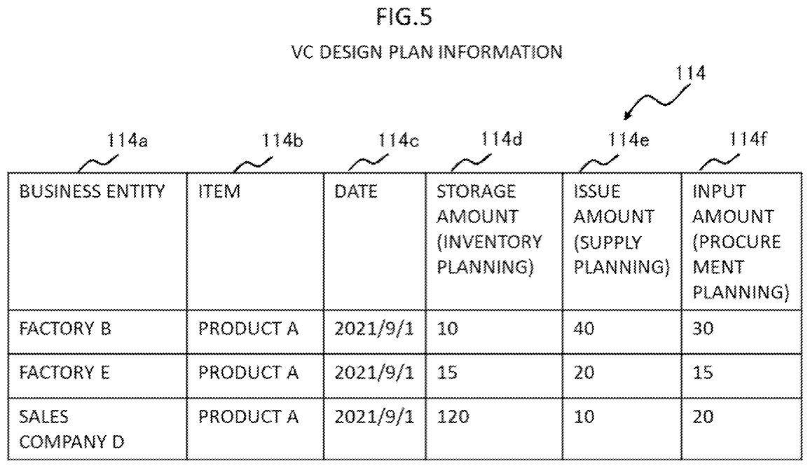

FIG. 5 is a diagram illustrating an example of the data structure of VC design plan information. VC design plan information 114 includes at least a combination of participating business entities that satisfy the demand included in the transaction. Specifically, the VC design plan information 114 includes a business entity 114a including a participating business entity participating in the value chain or a member business entity that procures using the value chain, a related item 114b, a date 114c that is the delivery date to the member business entity, a storage amount 114d that constitutes the state of the business entity's goods input and issue as of date 114c, an issue amount 114e, and an input amount 114f.

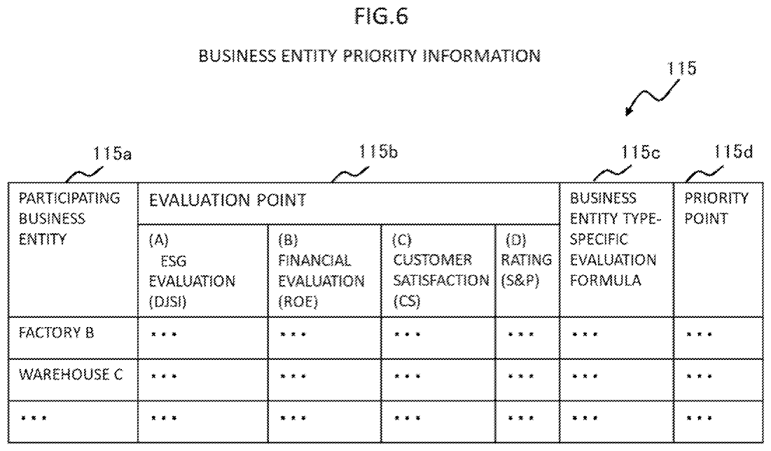

FIG. 6 is a diagram illustrating an example of the data structure of the participating business entity priority information. The participating business entity priority information 115 contains priority points indicating at least the degree to which incorporation into the value chain is prioritized for each participating business entity constituting the value chain.

Specifically, in the participating business entity priority information 115, for each participating business entity 115a, an evaluation point 115b, a business entity type-specific evaluation formula 115c for calculating priority points using the evaluation points, and a priority point 115d are associated and stored. Evaluation point 115b include various evaluation points, but to name a few, (A) ESG evaluation (further, for example, DJSI: Dow Jones Sustainability Index), (B) financial evaluation (further, ROE: Return On Equity), (C) Customer Satisfaction, (D) Rating (further, for example, S&P issuer ratings) and the like. However, it may not be limited to this and may include other evaluation points. In particular, ESG evaluation may be not only an ESG assessment as an investment related indicator, but also an evaluation of SDGs (Sustainable Development Goals) or an assessment of the environment, society, and governance.

The business entity type-specific evaluation formula 115c stores an evaluation formula according to the type of value provided by the participating business entity specified by the participating business entity 115a. The evaluation formula calculates a priority point indicating the priority of the participating business entity incorporated in the value chain construction. The priority point is calculated using the evaluation point 115b, and the calculation algorithm is shown by the business entity type-specific evaluation formula 115c for the business entity type. For example, the evaluation formula may be one in which each of the evaluation points (A) to (D) is evaluated on a 100-point scale, and each is multiplied by a weighting coefficient according to the type of value provided by the business entity to make it a priority point. This is because, if the type of value provided by the business entity is different, the evaluation points to be prioritized may also differ.

Priority point 115d indicates the priorities of the participating business entities to be incorporated in the value chain construction. The priority point 115d is calculated using the evaluation point 115b by the business entity type-specific evaluation formula 115c.

The usage of the priority point 115d may be diverse. For example, in the design of the value chain by the value chain design unit 121, it can be used to give priority to the participating business entities with high evaluations regarding the environment, society, and corporate governance among the participating business entities that constitute the value chain candidates. That is, emphasis can be placed on the ESG evaluation of (A) among the evaluation points.

Alternatively, it can be used to give priority to participating business entities with high evaluations of a given rating. That is, emphasis may be placed on the finances and ratings of (B) or (D) of the assessment points. Alternatively, it can be used to give priority to participating business entities with high evaluations from recipients of services. That is, emphasis can be placed on customer satisfaction of (C) among the evaluation points.

Return to the explanation in FIG. 1. When the value chain design unit 121 receives demand information including the necessary demand and delivery date from the business entity that procures using the value chain, the value chain design unit 121 calculates a combination of participating business entities that satisfy the demand information as a value chain candidate. In addition, the value chain design unit 121 gives priority to participating business entities with high evaluations in terms of the Environment, Social, and Corporate Governance among the participating business entities constituting the value chain candidates. Alternatively, the value chain design unit 121 may give priority to participating business entities with high evaluations related to a predetermined rating, or may give priority to participating business entities with high evaluations from recipients of services.

When the value chain execution unit 122 receives an instruction to approve any of the value chain candidates, it instructs the participating business entities constituting the approved value chain candidates to place an order. Specifically, the value chain execution unit 122 instructs the participating business entity to either place a confirmed order if the delivery date is within the lead time, a pre-order if the delivery date is outside the lead time, or disclose information if the delivery date is undecided.

The participating business entity registration unit 123 accepts a value that can be provided, the cost of the value, and the lead time for providing the value for each participating business entity participating in the value chain, and stores it in the participating business entity model information 111. More specifically, the participating business entity registration unit 123 accepts input of the business entity type, accepts the value that can be provided according to the model prototype according to the business entity type, the cost of the value, and the lead time provided for the value, and constructs a business entity model.

The priority calculation unit 124 generates the participating business entity priority information 115. Specifically, the priority calculation unit 124 acquires the evaluation point of the participating business entity at a predetermined timing from an external rating information provider, etc., not shown in the figure, and stores it in the evaluation point 115b of the participating business entity priority information 115, and recalculates and updates the priority point 115d.

The review processing unit 125 calculates the degree of delay in delivery for the participating business entities constituting the value chain executed in the value chain execution unit 122, and if there is a delivery delay of a predetermined threshold or more, a substitute value chain candidate is generated by the participating business entity that can be substituted.

The input unit 130 receives input information that is displayed and operated on the screen, for example, and is operated and input by a keyboard or mouse.

For example, the output unit 140 creates screen information including information output as a result of performing a predetermined process, and outputs it to a display computer.

The communication unit 150 communicates with other devices via the network. For example, the communication unit 150 can be communicatively connected to the participating business entity terminal 200 mainly used by the participating business entity or the member business entity terminal 300 mainly used by the member business entity.

The participating business entity terminal 200 and the member business entity terminal 300 are basically the same terminal, and the member business entity terminal 300 can act as a participating business entity terminal 200 when the participating business entity acts as not only the member business entity but also the participating business entity.

The participating business entity terminal 200 includes an inventory storage unit 210, a processing unit 220, a state confirmation unit 221 that is a part of the processing unit 220, an input unit 230, an output unit 240, and a communication unit 250.

Although not shown, inventory information managed by the participating business entity using the participating business entity terminal 200 is stored in the inventory storage unit 210. Simply, the inventory storage unit 210 has information on the inventory amount, the input amount, and the amount of goods issued for items handled for a certain period of time as inventory information.

The state confirmation unit 221 transmits the inventory state to the value chain providing apparatus 100 at a predetermined timing or periodically or intermittently with reference to the inventory storage unit 210, and also receives a notification or order instruction from the value chain providing apparatus 100.

The input unit 230 receives input information that is displayed and operated on the screen, for example, and is operated and input by a keyboard or mouse.

For example, the output unit 240 creates screen information including information output as a result of performing a predetermined process, and outputs it to a display computer.

The communication unit 250 communicates with other devices via the network. For example, the communication unit 250 can be communicatively connected to the value chain providing apparatus 100 or with the member business entity terminal 300 mainly used by the member business entity.

The member business entity terminal 300 includes a processing unit 320, a requesting unit 321 that is a part of the processing unit 320, an input unit 330, an output unit 340, and a communication unit 350.

The requesting unit 321 is configured with an Internet browser or the like, and transmits a request for design/execution of the value chain and input information to the value chain providing apparatus 100, and receives output information such as a screen display from the value chain providing apparatus 100.

The input unit 330 receives input information that is displayed and operated on the screen, for example, and is operated and input by a keyboard or mouse.

For example, the output unit 340 creates screen information including information output as a result of performing a predetermined process, and outputs it to a display computer.

Communication unit 350 communicates with other devices via the network. For example, the communication unit 350 can be communicatively connected to the value chain providing apparatus 100 or with the participating business entity terminal 200 mainly used by the participating business entity.

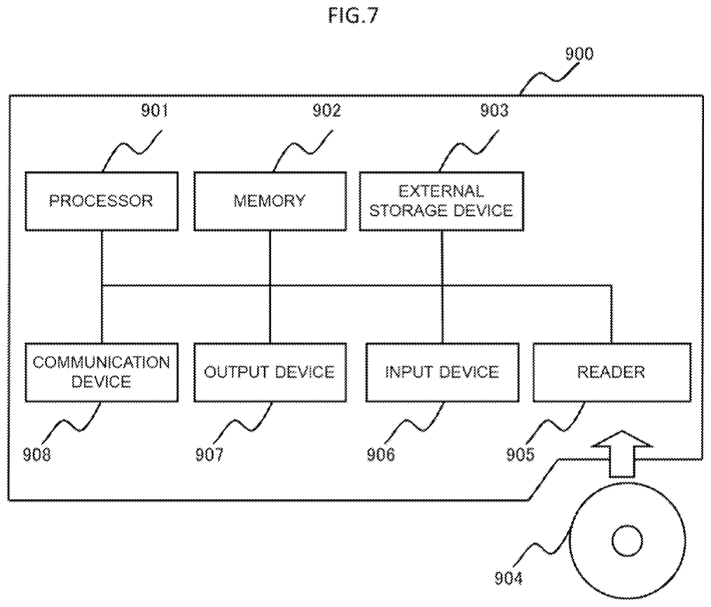

FIG. 7 is a diagram illustrating a hardware configuration example of the value chain providing apparatus. The value chain providing apparatus 100 is a general computer 900 having a processor (eg, CPU or GPU) 901, a memory 902 such as RAM (Random Access Memory), an external storage device 903 such as a hard disk drive (HDD) and SSD, and a reader 905 that reads information for portable storage media 904 such as CDs and DVDs, an input device 906 such as a keyboard, a mouse, a bar code reader and a touch panel, an output device 907 such as a display, and a communication device 908 that communicates with other computers via a communication network such as LAN or the Internet, or the computer 900 can be implemented in a network system having a plurality of these. Needless to say, the reader 905 may be capable of not only reading but also writing to the portable storage media 904.

For example, the value chain design unit 121, the value chain execution unit 122, the participating business entity registration unit 123, the priority calculation unit 124, and the review processing unit 125 included in the processing unit 120 can be realized by loading a predetermined program stored in the external storage device 903 into the memory 902 and executing it on the processor 901, and the input unit 130 can be realized by the processor 901 using the input device 906, the output unit 140 can be realized by the processor 901 using the output device 907 or the communication device 908, and the communication unit 150 can be realized by the processor 901 using the communication device 908, and the storage unit 110 can be realized by the processor 901 using the memory 902 or the external storage device 903.

This predetermined program may be downloaded to the external storage device 903 from a portable storage media 904 via the reader 905 or from the network via the communication device 908, and then loaded onto the memory 902 so that it is executed by the processor 901. It may also be loaded directly onto the memory 902 from the portable storage media 904 via the reader 905 or from the network via the communication device 908 and executed by the processor 901. Not limited to this, the value chain providing apparatus 100 may be a wearable computer worn by the worker, such as a headset, goggles, glasses, or income.

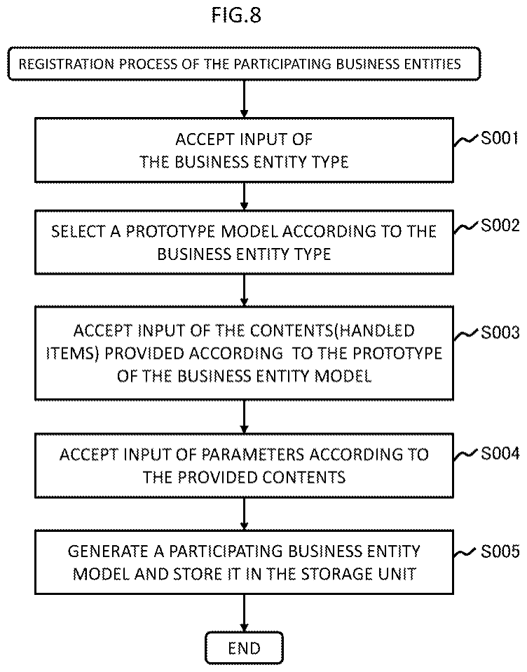

FIG. 8 is a diagram illustrating an example of the flow of the registration process of participating business entities. The registration process of the participating business entities is started when the value chain providing apparatus 100 accepts a start instruction from the user via the interface device.

First, the participating business entity registration unit 123 accepts input of the business entity type (step S001). Specifically, the participating business entity registration unit 123 accepts business entity types that are selectively entered from “sales companies, warehouses, manufacturing industries, transportation industries, suppliers” and the like by list boxes and the like.

Then, the participating business entity registration unit 123 selects a prototype model according to the business entity type (step S002). Specifically, the participating business entity registration unit 123 identifies a prototype of the business entity model according to the business entity type. In the business entity model, various business flows, processes, paperwork processing, money receipt and disbursements, etc. are registered as prototypes by default according to the business entity type, and after selecting these, it is possible to construct a business entity model by overwriting the unique parameters (for example, handled items, etc.) of each business entity. For example, in the transportation industry, the business flow differs significantly from the manufacturing industry due to the relationship that provides value for distributing products and parts among other business operators. This is because, the manufacturing industry calculates costs based on unit prices of parts and products, whereas the transportation industry calculates costs based on transportation distance, volume, and the like.

Then, the participating business entity registration unit 123 accepts input of the contents (handled items) provided according to the prototype of the business entity model (step S003). Specifically, the participating business entity registration unit 123 accepts handled items (subject to the value to be provided) that are selectively entered from “precision instruments, fixtures, food products, freezing, . . . ”, etc. by list box or the like.

Then, the participating business entity registration unit 123 accepts input of parameters according to the provided contents (handled items) (step S004). Specifically, the participating business entity registration unit 123 accepts parameter items and values that are selectively entered from “price, standard processing time, production plan, performance upper limit . . . ” and the like by a list box or the like.

Then, the participating business entity registration unit 123 generates a participating business entity model and stores it in the storage unit 110 (step S005). Specifically, the participating business entity registration unit 123 generates a participating business entity model from a prototype reflecting the provided contents received in step S003 and the parameters accepted in step S004, and stores the participating business entity model in the participating business entity model information 111.

The above is an example of the flow of the registration process of participating business entities. According to the flow of the registration process of participating business entities, participating business entities can be registered and made incorporable when building the value chain.

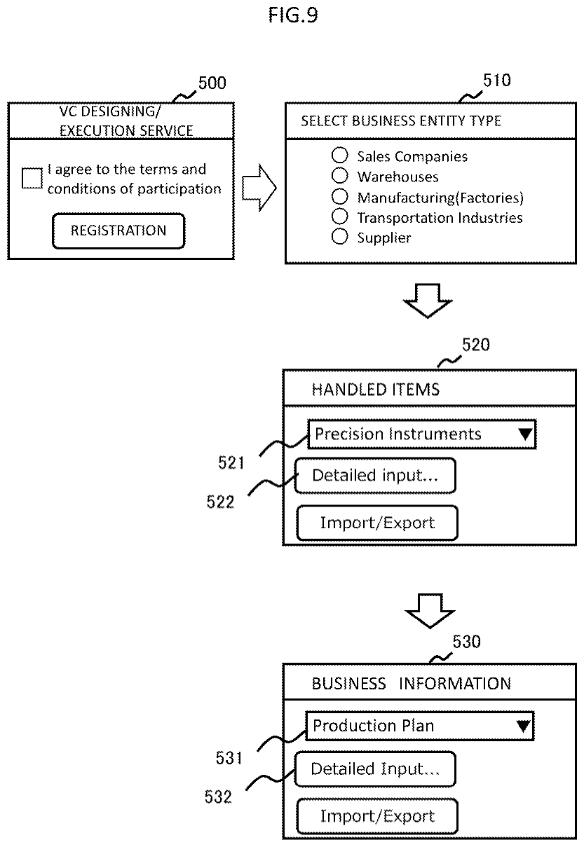

FIG. 9 is a diagram illustrating a screen example of the registration process of participating business entities. When confirmation of intention to participate is received on screen 500, the registration process of participating business entity registration is started, and the process transitions to the reception screen 510 for input of the business entity type in step S001. Then, when the input of the business entity type is accepted, the process transitions to the reception screen 520 for the input of the provided contents (handled items) in step S003. Then, when the input of the provided content (handled items) is accepted, the process transitions to the reception screen 530 for input of parameters according to the provided contents (handled items) in step S004.

By such a screen transition of the registration process of participating business entities, it can be said that business entities wishing to participate can not only easily participate as participating business entities, but also ensure the diversity and resilience of the value brought by the value chain.

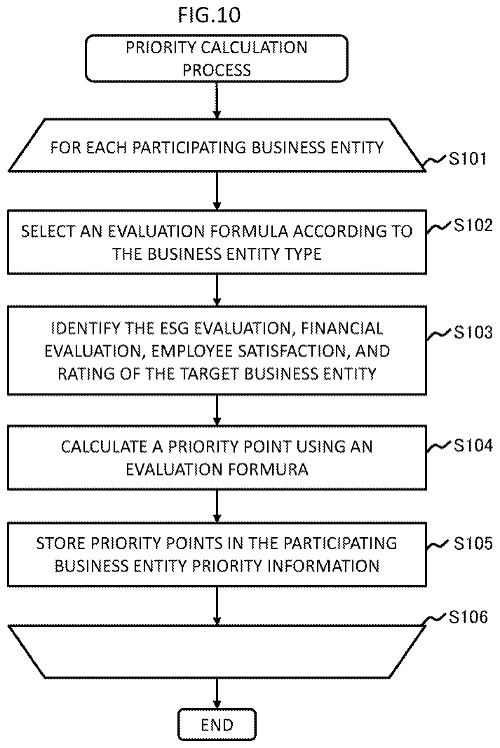

FIG. 10 is a diagram illustrating an example of the flow of priority calculation process. The priority calculation process shall begin after the completion of the registration process for participating business entities.

First, the priority calculation unit 124 performs the processing of step S102 to step S105 for each of the participating business entities (steps S101, step S106). Specifically, the priority calculation unit 124 reads the participating business entity model from the participating business entity model information 111 and processes it for each participating business entity.

The priority calculation unit 124 selects an evaluation formula according to the business entity type (step S102). Specifically, the priority calculation unit 124 reads out the business entity type 111b of the target business entity and identifies a predetermined evaluation formula that is predetermined in advance corresponding to the business entity type.

Then, the priority calculation unit 124 identifies the ESG evaluation, financial evaluation, employee satisfaction, and rating of the target business entity (step S3103). Specifically, the priority calculation unit 124 acquires the evaluation points of the participating business entities at a predetermined timing from an external rating information provision apparatus or the like not shown in the illustration and stores them in the evaluation point 115b of the participating business entity priority information 115.

Then, the priority calculation unit 124 calculates a priority point using an evaluation formula (step S104). Specifically, the priority calculation unit 124 calculates the priority points of the target business entity by substituting the evaluation points specified in step S103 to the evaluation formula specified in step S102.

Then, the priority calculation unit 124 stores priority points in the priority point 115d of the participating business entity priority information 115 (step S105).

The above is an example of the flow of priority calculation process. According to the flow of the priority calculation process, priority points can be calculated from the evaluation points for each participating business entity and priorities to be incorporated into the value chain can be determined.

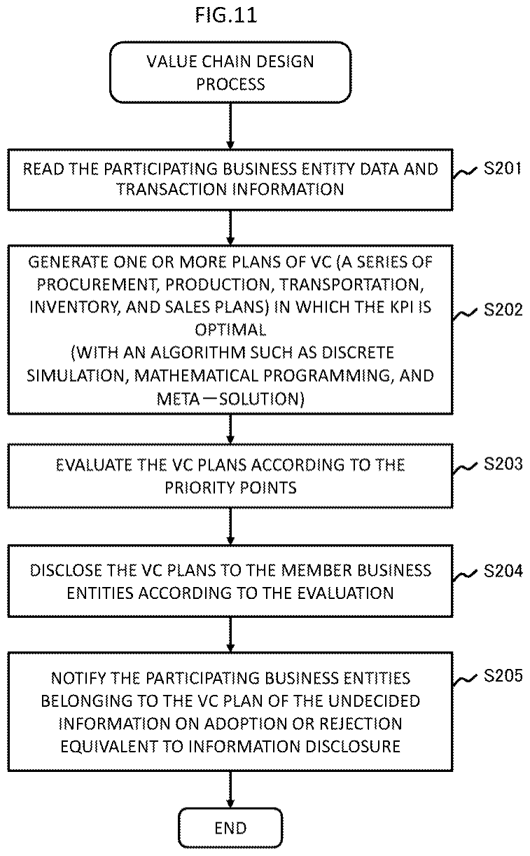

FIG. 11 is a diagram illustrating an example of the flow of the value chain design process. The value chain design process is started when the value chain providing apparatus 100 receives a start instruction from the user (for example, a person in charge of a member business entity or an operator of the value chain providing apparatus) via an interface device.

First, the value chain design unit 121 reads the participating business entity data and transaction information (step S201). Specifically, the value chain design unit 121 reads the participating business entity model information 111, the transaction information 113, and the participating business entity priority information 115.

Then, the value chain design unit 121 generates one or more plans of VC (Value Chain: a series of procurement, production, transportation, inventory, and sales plans) in which the KPI (Key Performance Indicator) is optimal using an algorithm such as discrete simulation, mathematical programming, and meta-solution (step S202).

Then, the value chain design unit 121 evaluates the VC plans according to the priority points (step S203). Specifically, the value chain design unit 121 sorts the VC plans for each VC plan according to the height of the average score of the priority point 115d of the participating business entities constituting the value chain.

Then, the value chain design unit 121 discloses the VC plans to the member business entities according to the evaluation (step S204). For example, the value chain design unit 121 accessibly transmits the predetermined number of VC plans sorted in step S202 in order to the requesting unit 321 of the member business entity terminal 300 of the member business entity that procures using the value chain. Here, the value chain design unit 121 masks and transmits information to be concealed other than the member business entity itself included in the VC plan.

Then, the value chain design unit 121 notifies the participating business entities belonging to the VC plan of the undecided information on adoption or rejection equivalent to information disclosure (step S205). That is, the value chain design unit 121 also accessibly transmits the corresponding VC plan to the state confirmation unit 221 of the participating business entity terminal 200 of the participating business entity that provides value to the VC plan disclosed in step S204. Here, the value chain design unit 121 masks and transmits information other than the participating business entity itself and the direct delivery destination included in the VC plan.

The above is an example of the flow of value chain design processing. According to the flow of the value chain design process, it is possible to notify member business entities of multiple VC plans with high priority points and to inform the relevant participating business entities that they may be incorporated into the VC plan. As a result, the participating business entity terminal 200 can start adjusting inventory and production in consideration of the possibility of being incorporated into the VC plan, so that it will be possible to provide value quickly when order is confirmed.

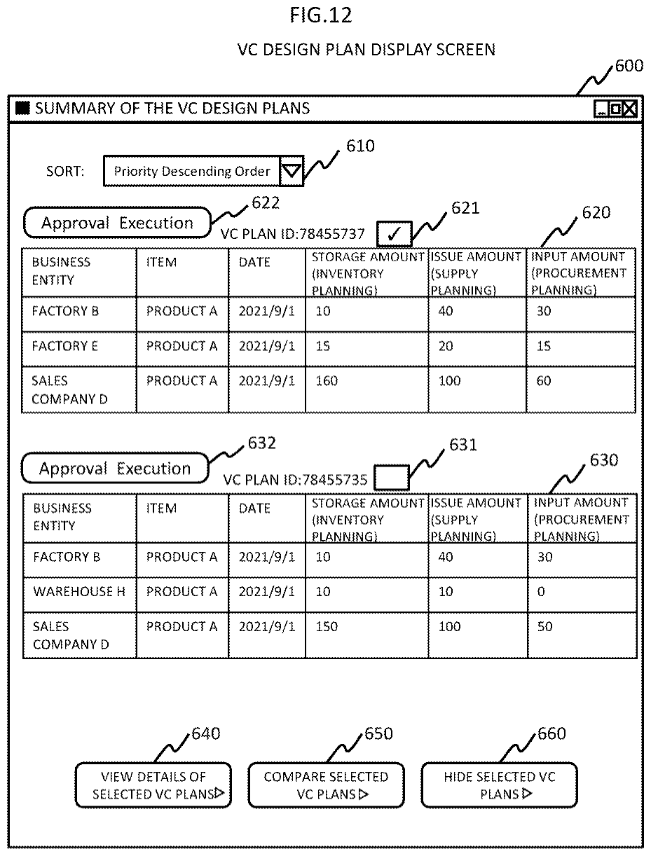

FIG. 12 is a diagram illustrating a screen example of value chain design process. The VC design plan display screen 600 is displayed by the requesting unit 321 of the member business entity terminal 300 in step S204 of the value chain design process. The VC design plan display screen 600 includes a sort instruction reception area 610, a VC plan display area 620, a VC plan selection input reception area 621, a VC plan approval execution instruction reception area 622, a runner-up VC plan display area 630, a runner-up VC plan selection input reception area 631, a runner-up VC plan approval instruction acceptance area 632, a detailed display instruction reception area 640, a comparison instruction reception area 650, and a non-display instruction reception area 660.

The sort instruction reception area 610 accepts input of a key for sorting VC plans to be displayed in the VC plan display area 620 and the runner-up VC plan display area 630. VC plans are displayed in the VC plan display area 620 and the runner-up VC plan display area 630, respectively. Further, the VC plan selection input reception area 621 and the runner-up VC plan selection input reception area 631 accept inputs for setting each VC plan in the selected state. When the VC plan approval execution instruction reception area 622 and the runner-up VC plan approval execution instruction reception area 632 accept input, they give execution instructions to the corresponding VC plan.

When the detailed display instruction reception area 640 accepts input, the screen transitions to the VC design plan detailed display screen 700 that displays the details of the VC plan selected in the VC plan selection input reception area 621 and the runner-up VC plan selection input reception area 631. When the comparison instruction reception area 650 accepts input, the screen transitions to a contrast screen that displays a comparison the VC plans selected in the VC plan selection input reception area 621 and the runner-up VC plan selection input reception area 631 and displays the portion with a large difference. The non-display instruction reception area 660 makes the VC plans selected in the VC plan selection input reception area 621 and the runner-up VC plan selection input reception area 631 non-display.

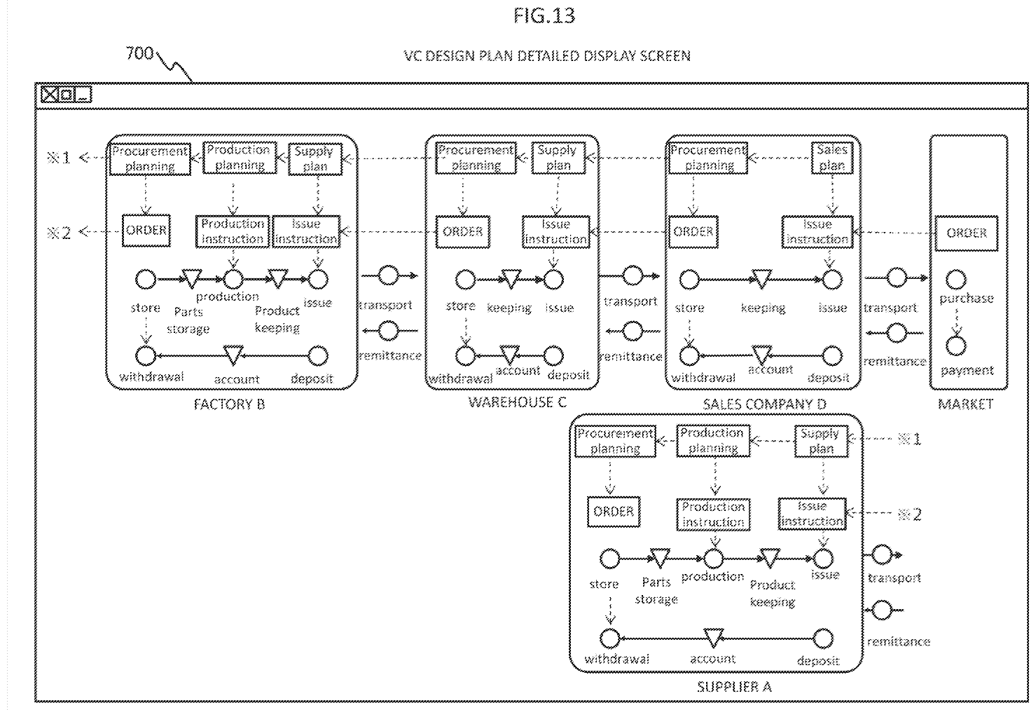

FIG. 13 is a diagram illustrating a detailed screen example of value chain design process. The VC design plan detailed display screen 700 is displayed when input is accepted to the detailed display instruction reception area 640 on the VC design plan display screen 600.

The VC design plan detailed display screen 700 illustrates detailed contents of value chain candidates. For example, on the VC design plan detailed display screen 700, the order in which the related participating business entities are involved and the processes performed in the participating business entities are displayed going back from downstream (market side) to upstream of the value chain. As a result, member business entities can confirm the details of value chain candidates.

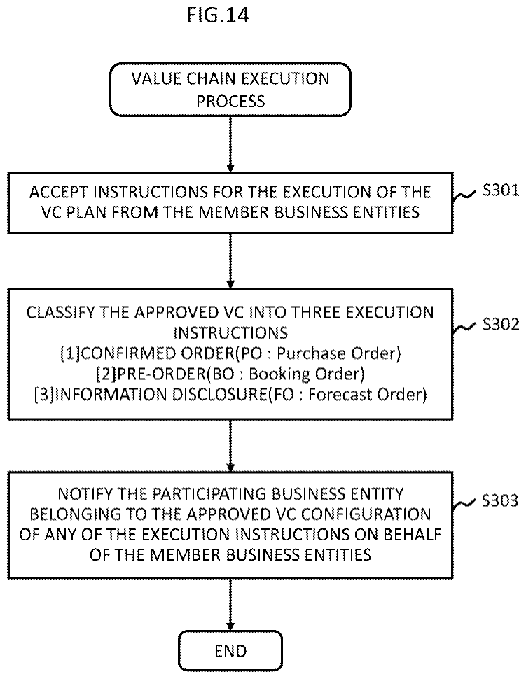

FIG. 14 is a diagram illustrating an example of the flow of value chain execution process. The value chain execution process is started in the value chain providing apparatus 100 when the value chain providing apparatus 100 finishes the value chain design process.

First, the value chain execution unit 122 accepts instructions for the execution of the VC plan from the member business entities (step S301). Specifically, the value chain execution unit 122 accepts input from the VC plan approval execution instruction reception area 622 and the runner-up VC plan approval execution instruction reception area 632 of the VC design plan display screen 600.

Then, the value chain execution unit 122 classifies the approved VC into three execution instructions (step S302). Specifically, the value chain execution unit 122 identifies whether to instruct the participating business entities constituting the approved value chain candidate to a confirmed order if the delivery date is within the lead time, a pre-order if the delivery date is outside the lead time, and information disclosure if the delivery date is undetermined.

Then, the value chain execution unit 122 notifies the participating business entity belonging to the approved VC configuration of any of the execution instructions on behalf of the member business entities (step S303). Specifically, the value chain execution unit 122 identifies the approved VC configuration, identifies the participating business entities that provide value in the VC, and notifies each of the identified participating business entities on behalf of the member business entities of the execution instructions of whether to place a confirmed order, a pre-order, or information disclosure.

The above is an example of the flow of value chain execution process. According to the value chain execution process, the selected value chain candidate can be executed.

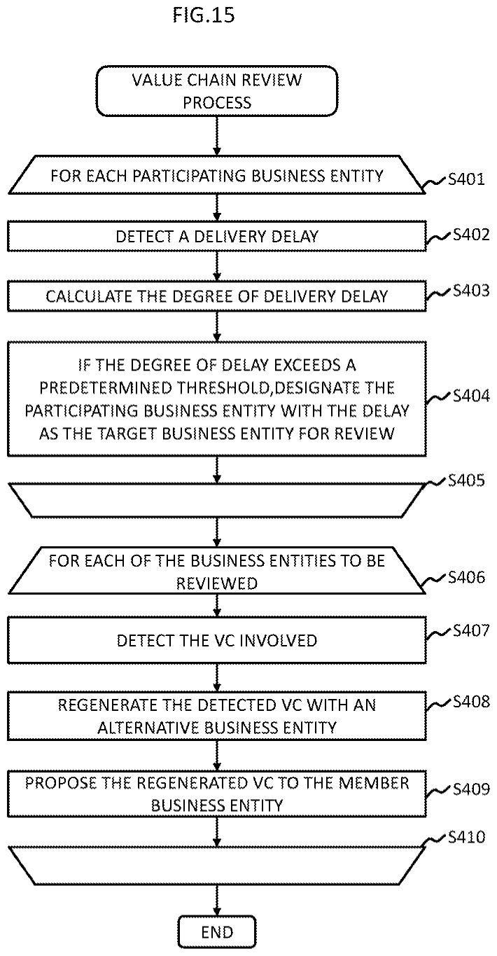

FIG. 15 is an example of the flow of the value chain review process. The value chain review process is started at a predetermined timing or periodically at the value chain providing apparatus 100 when the value chain providing apparatus 100 finishes the value chain execution process.

First, the review processing unit 125 identifies the participating business entities for the value chain being executed and executes the processing in steps S402 to S404 for each participating business entity (steps S401, S405).

The review processing unit 125 detects a delivery delay (step S402). Specifically, the review processing unit 125 extracts the delivery date between each business entity in the value chain and determines whether the inventory amount fluctuates more than the necessary amount by the delivery date. If there is no fluctuation more than necessary, it is detected as if there has been a delay in delivery of the upstream business entity.

Then, the review processing unit 125 calculates the degree of delivery delay which is the degree of delivery delay for each participating business entity (step S403). Specifically, the review processing unit 125 calculates the degree of delay in delivery by counting the number of inventory fluctuations that are insufficient for each delivery delay and summing them up for each participating business entity.

If the degree of delay in delivery exceeds a predetermined threshold, the review processing unit 125 designates the participating business entity with the delay in delivery as the target business entity for review (step S404).

Then, the review processing unit 125 performs the processing in steps S407˜S409 for each of the business entities to be reviewed (steps S406 and S410).

The review processing unit 125 detects the VC involved (step S407). Specifically, the review processing unit 125 detects the value chain in which the business entity to be reviewed participates.

Then, the review processing unit 125 regenerates the detected VC with an alternative business entity (step S408).

Specifically, in the value chain detected in step S407, the review processing unit 125 generates a value chain candidate that substitutes the business entity to be reviewed with another company in the same industry.

Then, the review processing unit 125 proposes the regenerated VC to the member business entity (step S409). Specifically, the review processing unit 125 accessibly transmits the VC plan regenerated in step S408 to the requesting unit 321 of the member business entity terminal 300 of the member business entity that procures using the value chain, and proposes an alternative. Here, the review processing unit 125 masks and transmits information to be concealed other than the member business entity itself included in the VC plan.

The above is an example of the flow of value chain review processing. According to the flow of the value chain review processing, if the quality of the value chain running is not appropriate, a proposal to switch to an alternative plan can be made. This makes it easier for member business entities to ensure their resilience.

The above is the configuration of the value chain providing system 1 according to the embodiment. According to the value chain providing system 1, it can be dynamically configured with efficient business entities in the latest state at the time of design of the value chain.

The present invention is not limited to the above-described embodiments, and includes various modifications. The embodiment described above has been described in detail for clearly explaining the invention, but is not necessarily to be considered limited to the inclusion of all of the configurations described. It is possible to replace a part of the configuration of the embodiment with another configuration. Further, it is possible to delete a part of the configuration of the embodiment.

The above-mentioned respective parts, configurations, functions, processing units, and the like may be partially or entirely achieved with hardware, for example, by designing with integrated circuits. The above-mentioned respective parts, configurations, functions, and the like may be achieved with software in a way that a processor interprets and executes programs for achieving the respective functions. Information such as programs, tables, and files for achieving the respective functions can be stored on a recording device such as a memory and a hard disk, or a storage medium such as an IC card, an SD card, and a DVD.

It is to be noted that control lines and information lines according to the above-mentioned embodiment are shown which are considered required for the sake of explanation, but the control lines and information lines required for a product may be not all shown. In fact, it is conceivable that almost all of the configurations are interconnected. The invention has been described above mainly with respect to the embodiment.

### REFERENCE SIGN LIST

1 value chain providing system
100 value chain providing apparatus
110 storage unit
111 participating business entity model information
112 member business entity information
113 transaction information
114 VC design plan information
115 participating business entity priority information
120 processing unit
121 value chain design unit
122 value chain execution unit
123 participating business entity registration unit
124 priority calculation unit
125 review processing unit
130 input unit
140 output unit
150 communication unit
200 participating business entity terminal
210 inventory storage unit
220 processing unit,
221 status confirmation unit
230 input unit
240 output unit
250 communication unit
300 member business entity terminal
320 processing unit
321 requesting unit
330 input unit
340 output unit
350 communication unit

What is claimed is:

1. A value chain providing apparatus for a value chain in which at least two or more business entities from material procurement to sales of products participate, comprising:
a storage unit;
a participating business entity registration unit configured to accept and store in the storage unit a value that can be provided, a cost of the value, and a provision lead time of the value from each participating business entity participating in the value chain; and
a value chain design unit configured to receive demand information including a necessary demand and a delivery date from a business entity that procures using the value chain, and calculate a combination of participating business entities satisfying the demand information as a value chain candidate.

2. The value chain providing apparatus according to claim 1, further comprising:
a value chain execution unit configured to receive an instruction to approve the value chain candidate, instruct the participating business entity constituting the approved value chain candidate to place an order.

3. The value chain providing apparatus according to claim 1, wherein
the value chain design unit gives priority to the participating business entity with a high evaluation regarding the environment, society, and corporate governance among the participating business entities constituting the value chain candidate.

4. The value chain providing apparatus according to claim 1, wherein
the value chain design unit gives priority to the participating business entity with a high evaluation of predetermined rating among the participating business entities constituting the value chain candidates.

5. The value chain providing apparatus according to claim 1, wherein
the value chain design unit gives priority to the participating business entity with a high evaluation from recipients of services among the participating business entities constituting the value chain candidate.

6. The value chain providing apparatus according to claim 1, further comprising:
a value chain execution unit configured to accept an instruction to approve the value chain candidate, and instruct the participating business entities constituting the approved value chain candidate to confirm order if the delivery date is within the lead time, pre-order if the delivery date is outside the lead time, and disclose information if the delivery date is undetermined.

7. The value chain providing apparatus according to claim 1, further comprising:
a value chain execution unit configured to accept an instruction to approve the value chain candidate, and instruct the participating business entity constituting the approved value chain candidate to place an order; and
a review processing unit configured to calculate a degree of delay in delivery for the participating business entity constituting the value chain that is executed, and if there is a delay in delivery exceeding a predetermined threshold, generate a value chain candidate to be substituted by a substitutable participating business entity.

8. The value chain providing apparatus according to claim 1, wherein
the participating business entity registration unit accepts input of a business entity type of the business entity, constructs a business entity model using the value, the cost of the value, and the provision lead time of the value, according to the model prototype corresponding to the business entity type.

9. A value chain providing system for a value chain in which at least two or more business entities from material procurement to sales of products participate, comprising:
a processing unit and a storage unit; wherein
the processing unit is configured to accept and store in the storage unit a value that can be provided, a cost of the value, and a provision lead time of the value from each participating business entity participating in the value chain, receive demand information including necessary demand and a delivery date from a business entity that procures using the value chain, and calculate a combination of participating business entities satisfying the demand information as a value chain candidate.

10. A value chain providing method using a value chain providing apparatus for a value chain in which at least two or more business entities from material procurement to sales of a product participate, the value chain providing apparatus executing steps of:
an accepting and storing step of accepting and storing in a storage unit a value that can be provided, a cost of the value, and a provision lead time of the value from each participating business entity participating in the value chain; and
a receiving and calculating step of receiving demand information including a necessary demand and a delivery date from a business entity that procures using the value chain, and calculating a combination of participating business entities satisfying the demand information as a value chain candidate.
